(19) United States
(12) Patent Application Publication
(10) Pub. No.: US 2011/0138272 A1
(43) Pub. Date: Jun. 9, 2011

(54) IMAGE FORMING APPARATUS AND DOCUMENT DESCRIPTION INFORMATION INPUT METHOD OF DOCUMENTS THEREOF

(75) Inventors: Jae-yoon LEE, Seoul (KR); Young-hoon Lee, Suwon-si (KR)

(73) Assignee: Samsung Electronics Co., Ltd, Suwon-si (KR)

(21) Appl. No.: 12/844,153

(22) Filed: Jul. 27, 2010

(30) Foreign Application Priority Data
Dec. 7, 2009 (KR) 2009-120308

(51) Int. Cl. G06F 3/048; G06F 17/24

(52) U.S. Cl. 715/255; 715/810

(57) ABSTRACT

An image forming apparatus and a document description information input method thereof includes a display unit on which a graphic user interface is displayed and a storing unit in which at least one document is stored, the document description information input method includes displaying a list including at least one document on the display unit; selecting at least one document from the list; determining whether there exists any description information set for the document, selecting a description information input menu if there exists no description information set for the document; and inputting the description information in the image forming apparatus using the description information input menu. With this configuration, it is possible to easily identify documents required by a user by inputting description information on documents stored in the apparatus through a GUI and storing the input description information to correspond to the stored document.

### CROSS-REFERENCE TO RELATED APPLICATIONS

This application claims priority under 35 U.S.C. §119 from Korean Patent Application No. 10-2009-0120308, filed on Dec. 7, 2009 in the Korean Intellectual Property Office, the disclosure of which is incorporated herein by reference in its entirety.

### BACKGROUND

1. Field of the General Inventive Concept

Apparatuses and methods consistent with the exemplary embodiments relate to an image forming apparatus and a document description information input method thereof, and more particularly, to an image forming apparatus which is input with document description information using a GUI on a touch screen, and a document description information input method thereof.

2. Description of the Related Art

An image forming apparatus forms an image to be printed on a printing medium such as a paper. Such an image forming apparatus may be implemented by a printer, a copier, a facsimile, a multifunction printer with two or more functions, or others known in the art.

The image forming apparatus may include a storage which stores various types of documents, which are created by tasks such as printing, scanning, faxing and the like, in the form of file, and a user may again print the documents stored in the storage whenever necessary.

However, if there are an increased number of documents stored in the storage or when much time has passed since the storing, it may be difficult for the user to identify the documents individually.

In particular, a user may have more difficulty in identifying documents created by a different user including altering, merging or splitting the stored documents or original documents.

Although such a conventional image forming apparatus may provide relevant information such as file names, thumbnail information, creators, creation dates and the like of the stored documents, it is difficult for the user to correctly identify the documents with only such limited information.

Therefore, the user may print and check all the stored documents to be identified, which results in a needless waste of time, paper, toner and the like.

In addition, even when the documents are printed, in case of a memory dump list composed of hexadecimal numbers, a photograph, a partially modified version of an original document, merged or split documents and the like depending on the kind of document, it is difficult to definitely identify whether or not these documents are documents required by a user.

### SUMMARY

Accordingly, exemplary embodiments provide an image forming apparatus which is capable of easily identifying stored documents needed by a user by inputting description information on the stored documents using a GUI, and associating the input description information with the stored documents, and a document description information input method thereof.

Exemplary embodiments also provide an image forming apparatus which is capable of providing a description information retrieval function so that a user can simply retrieve documents needed by the user, and a document description information input method thereof.

Additional features and utilities of the present general inventive concept will be set forth in part in the description which follows and, in part, will be obvious from the description, or may be learned by practice of the general inventive concept.

Embodiments of the present general inventive concept may be achieved by providing a document description information input method in an image forming apparatus including a display unit on which a graphic user interface is displayed and a storing unit in which at least one document is stored, including displaying a list including at least one document on the display unit, selecting at least one document from the list, determining whether there exists any description information set for the document, selecting a description information input menu if there exists no description information set for the document, and inputting the description information in the image forming apparatus using the description information input menu.

The document description information input method may include displaying the selected document and the description information together if there exists any description information set for the document.

The document description information input method may further include storing the input description information as meta data contained in the document or storing the input description information in the form of a separate file, and the separate file may be linked with the document.

The stored description information may be editable.

The inputting the description information may include inputting the description information using a soft keyboard in the graphic user interface of the image forming apparatus or using input buttons of the image forming apparatus.

The document may be retrievable using the input description information.

The document retrieval may be performed using the graphic user interface or by an external device connectable to the image forming apparatus.

The document description information input method may further include merging a plurality of documents stored in the storing unit into a single document or splitting a single document into a plurality of documents, and, for the merging or the splitting, the set description information may be edited or new description information may be input.

Embodiments of the present general inventive concept may also be achieved by providing an image forming apparatus which is capable of inputting description information, including a display unit on which a graphic user interface is displayed, a user input unit which receives a user selection in to correspond to the displayed graphic user interface, a storing unit in which at least one document is stored, and a control unit which controls the display unit to display a list including the at least one document stored in the storing unit, determines whether there exists any description information set for the document upon receiving a selection of at least one document from the list through the user input unit, and controls the display unit to display a graphic user interface to allow for a selection of a description information input menu and input of the description information using the description information input menu if there exists no description information set for the document.

The selected document and the description information may be displayed together if there exists any description information set for the document.

The control unit may store the input description information as meta data contained in the document or store the input description information in the form of a separate file linked with the document.

The stored description information may be editable.

The user input unit may include at least one of a soft keyboard in the graphic user interface and input buttons.

The document may be retrievable using the input description information.

The document retrieval may be performed using the graphic user interface or by an external device connectable to the image forming apparatus.

The user input unit may select to merge a plurality of documents stored in the storing unit into a single document or split a single document into a plurality of documents, and, for the merging or the splitting, the set description information may be edited or new description information may be input.

Embodiments of the present general inventive concept may also be achieved by providing an image forming apparatus which is capable of inputting description information, including an operation unit which receives a user selection through a touch screen on which a graphic user interface is displayed, a storing unit in which at least one document is stored, and a control unit which controls the operation unit to display a list including the at least one document stored in the storing unit, determines whether there exists any description information set for the document upon receiving a selection of at least one document from the list through the touch screen, and controls the operation unit to display a graphic user interface to allow for a selection of a description information input menu and input of the description information using the description information input menu if there exists no description information set for the document.

As described above, according to the image forming apparatus and the document description information input method of the present general inventive concept, it is possible to easily identify documents required by a user by inputting description information on documents stored in the apparatus through a GUI and storing the input description information to correspond to the stored document.

Embodiments of the present general inventive concept may also be achieved by displaying a selectable document list on the display unit with corresponding check boxes to select at least one document, selecting at least one of the documents from the document list to view description information about the document, displaying a detail information screen on the display unit in order to view the description information about the document, and determining from the detail information screen whether additional description information is available for the selected document.

A button may be included on the display unit in order to view the description information about the document.

The determining from the detail information screen may include determining whether a description information button is blinking or illuminated to indicate whether additional description information is available for the selected document.

The determining from the detail information screen may include determining whether a document information area exists for the selected document.

Embodiments of the present general inventive concept may also be achieved by providing an image forming apparatus which is capable of inputting description information, including a display unit to display a selectable document list with corresponding check boxes to select at least one document and to display a detail information screen in order to view description information about the document, a user input unit to allow a user to select at least one of the documents from the document list to view the description information about the document and determine from the detail information screen whether additional document information is available for the selected document.

The apparatus may further include a description information button on the display unit in order to view the description information about the document.

The description information button may blink or illuminate to indicate whether additional description information is available for the selected document.

The detail information screen may include a detail information area to indicate whether additional description information is available for the selected document.

In addition, it is possible to improve user's convenience of simple retrieval of documents required by a user by providing a description information retrieval function.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings, in which:

FIG. 1 is a block diagram illustrating a configuration of an image forming apparatus according to an exemplary embodiment of the present general inventive concept;

FIG. 2 is a view illustrating a document list screen according to an exemplary embodiment of the present general inventive concept;

FIG. 3 is a view illustrating a document detail information screen according to an exemplary embodiment of the present general inventive concept;

FIG. 4 is a view illustrating a document description information screen according to an exemplary embodiment of the present general inventive concept;

FIGS. 5 and 6 are views illustrating data input on a touch screen according to an exemplary embodiment of the present general inventive concept;

FIG. 7 is a flow chart illustrating a document description information input process in the image forming apparatus according to an exemplary embodiment of the present general inventive concept;

FIG. 8 is a flow chart illustrating a document description information input process in the image forming apparatus according to another exemplary embodiment of the present general inventive concept; and

FIG. 9 is a flow chart illustrating a description information retrieval process using description information.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

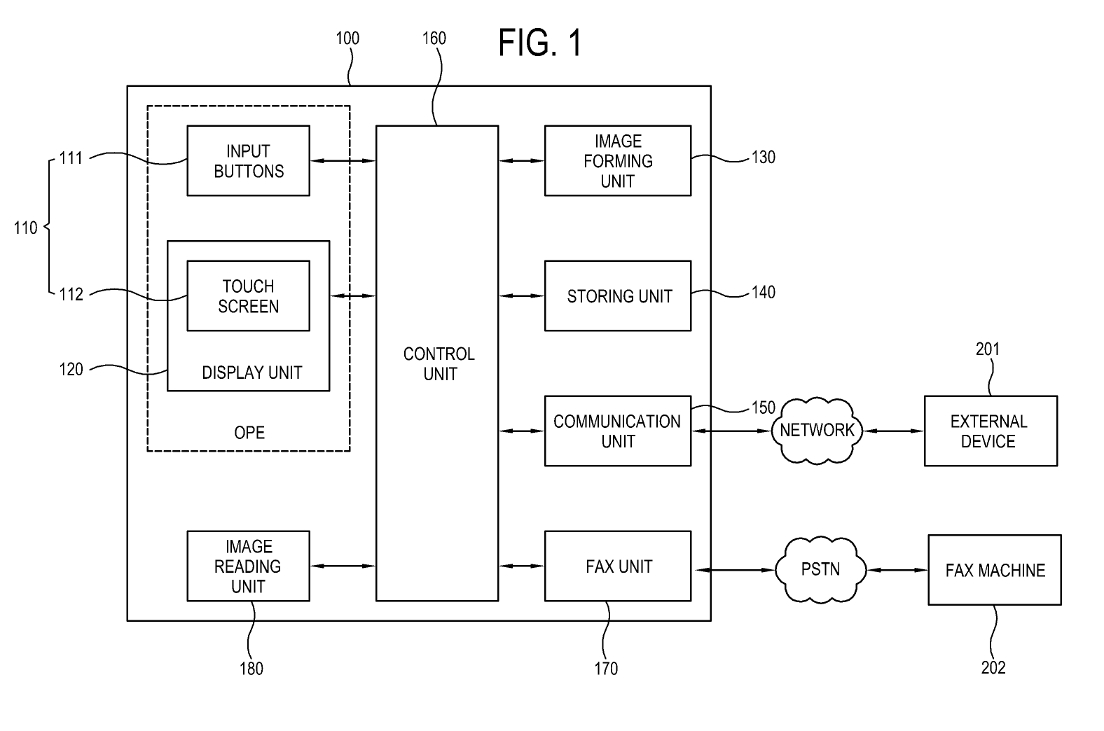

FIG. 1 is a block diagram illustrating a configuration of an image forming apparatus 100 according to an exemplary embodiment of the present general inventive concept. The image forming apparatus 100 may be implemented by a printer, a multifunction printer with two or more of print, copy, scan and fax functions, or others known in the arts.

As illustrated in FIG. 1, in an exemplary embodiment, the image forming apparatus 100 includes a user input unit 110, a display unit 120, an image forming unit 130, a storing unit 140, a communication unit 150 and a control unit 160. The image forming apparatus 100 may further include a fax unit 170 and an image reading unit 180, as illustrated in FIG. 1.

The user input unit 110 may receive data and/or instructions from a user.

The user input unit 110 may include one or more input buttons 111 (hereinafter also referred to as “hard key” or “key pad”) and a touch screen 112 (hereinafter also referred to as “touch panel” or “touch pad”) which may receive instructions through touch by a user.

The input buttons 111 may include numeric keys such as 0, 1, 2, . . . , 9 and functional keys such as *, # and the like. Here, the input buttons 111 may include a hard keyboard through which characters can be input.

The touch screen 112 may include a graphic user interface (GUI) (hereinafter also abbreviated as “UI”) which may be created by execution of a predetermined application and may be displayed on the display unit 120 to allow a user to input instructions in a touch manner.

In an exemplary embodiment, the GUI may include a list of documents stored in the storing unit 140 of the image forming apparatus 100, a soft keyboard (hereinafter also referred to as “virtual keyboard”) for input of description information regarding the stored documents, a handwriting input window (hereinafter also referred to as a “scribing input window”) to allow a user to input instructions manually, and so on.

In an exemplary embodiment, the user input unit 110 of the image forming apparatus 100 may further include an electronic pen (or a digital pen) which is separately provided to handwrite input by the user, and an optical character reader (OCR) which is capable of character recognition using the electronic pen or by other OCR techniques.

The user may perform a log-in process to input his/her own assigned ID and password through the user input unit 110. In an exemplary embodiment, the log-in may include a log-in in an administrator mode in which setting and alteration of all environments of the image forming apparatus 100 are possible with no access restriction.

When a log-in process by the user or the log-in of the administrator mode is performed, the image forming apparatus 100 may perform a user identification process and an access permission process. In an exemplary embodiment, the user may be intended to include an administrator.

The display unit 120 may display a UI screen which shows settings and operation conditions of the image forming apparatus 100 to the user and receives various instructions from the user. The display unit 120 may include, for example, a liquid crystal display (LCD) and a driver (not illustrated) which drives the LCD.

In the image forming apparatus 100 of an exemplary embodiment, the user input unit 110 may be implemented with a range of GUIs selectable by the user using the touch screen 112 on the display unit 120. That is, the user input unit 110 and the display unit 120 are not separated from each other but may be provided as a single configuration.

In the image forming apparatus 100 of an exemplary embodiment, a single configuration including the user input unit 110 and the display unit 120 may be referred to as an operation unit (hereinafter also referred to as an “operation panel equipment (OPE) unit.”

The operation unit may be provided, as the user input unit 110, with a character-inputtable hard keyboard having numeric keys and functional keys.

The display unit 120 may display a list including documents stored in the storing unit 140 of the image forming apparatus 100 on the touch screen which may be selectable by the user and may include a soft keyboard to input description information regarding the stored documents through the touchscreen 112 by the touch, a handwriting input window to manually or hand write input of the user, etc.

Upon receiving a print instruction, the image forming unit 130 may form an image to be printed on at least one printing medium (paper) based on print data. In an exemplary embodiment, the printing may include printing received fax data, printing a copy of a document after scanning the document, and printing print data which may be received from outside of the image forming apparatus through a host device including a server or stored in internal (for example, a hard disk drive (HDD)) or external (for example, a universal serial bus (USB) memory of the image forming apparatus 100.

The storing unit 140 may store various types of print data for printing operations, fax data for fax transmission, image data scanned through the image reading unit 180, data which may be received from an external device 201 including a host device, a PC, a server or the like which may be connected via the communication unit 150, a variety of setting information of the image forming apparatus 100 which may be input through the user input unit 110, user authentication information for each user account, user authority information, etc. In addition, the storing unit 140 may also store fax data which may be received from an external fax machine 202 via the fax unit 170.

In an exemplary embodiment, the storing unit 140 of the image forming apparatus 100 may also store description information on various types of stored data, i.e., documents.

In an exemplary embodiment, the description information may be stored to correspond to the documents stored in the storing unit 140. More specifically, documents of a format to support meta data, such as prn files, may be stored as files including description information as meta data. For documents of a format which does not support meta data, description information may be stored as a separate file, and original documents and the description information may be stored with them interlinked by a link.

The storing unit 140 may include, for example, an internal storage medium such as a HDD, an external or portable storage medium such as a USB memory, a memory card (for example, a memory stick, a compact flash (CF) card, a multi media card (MMC), etc.), or a memory card slot, or others known in the art.

As illustrated in FIG. 1, the communication unit 150 may conduct data communication with the external device 201 including a host device or a server to receive print data written with a predetermined print language therefrom.

The communication unit 150 may include a wired/wireless communication unit that may include a mode which can be networked with the external device 201 such as a host device either locally or by a predetermined protocol, an interface (for example, a USB port) which can be coupled to a portable storage medium such a USB memory, etc.

The communication unit 150 may transmit a scanned image to the external device 201 such as a host device or a server according to a predetermined protocol using a scan-to-host function or a scan-to-server function, or transmit the scanned image to the external device 201 using a scan-to-email function, or may transmit the scanned image to a connected USB memory for storage using a scan-to-USB function.

The fax unit 170 may include a fax communication module (for example, a modem) which can convert image data generated by the image reading unit 180 into a fax signal and transmits the fax signal to the external fax machine 202 (including a multifunction printer with a fax function) using a fax network (for example, a public switched telephone network (PSTN)), or may receive a fax signal from the external fax machine 202.

The image reading unit 180 may read a document to be scanned and may generated scanned data based on the read document. The document to be scanned may be, for example, a document, a photograph, a film and the like. The image reading unit 180 may include a photo-converting device such as a charge-coupled device (CCD) or a Contact image sensor (CIS), and an image processor which may convert a document into image data using a signal output from the photo-converting device. In addition, the image reading unit 180 may further include a scan motor which drives the photo-converting device and the image processor, and a guide.

Scanned data generated by the image reading unit 180 may be converted into a fax signal to be transmitted by the fax unit 170 to the external fax machine 202.

The control unit 160 may control the overall operation of the image forming apparatus 100.

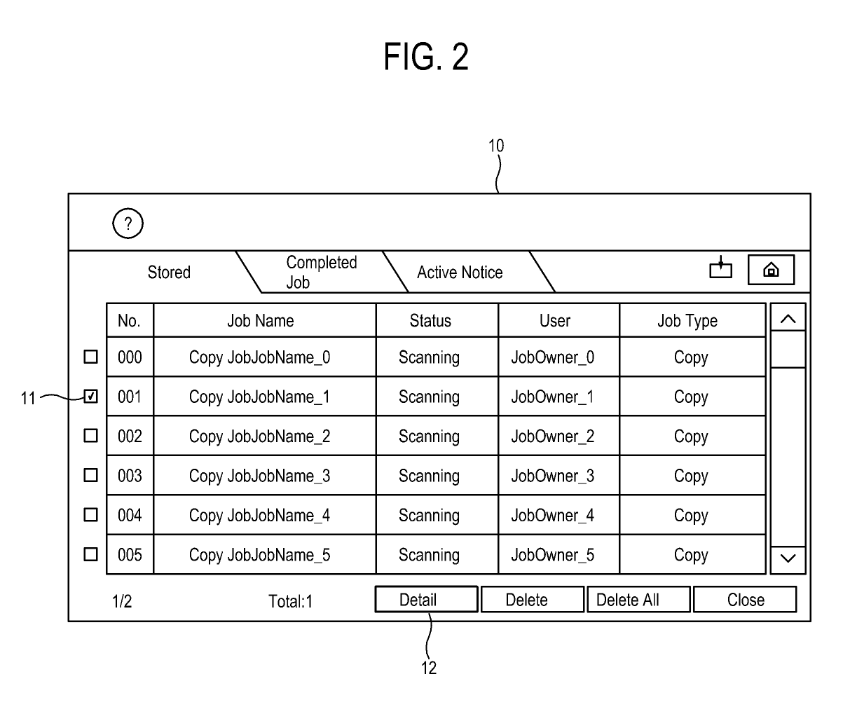

In more detail, the control unit 160 may control the display unit 120 to display a document list screen 10 (illustrated in FIG. 2) which may be a touch screen including at least one document stored in the storing unit 140 of the image forming apparatus 100. In this embodiment, the at least one document stored in the storing unit 140 may include documents stored in not only an internal storage such as a HDD but also an external storage such as a USB memory.

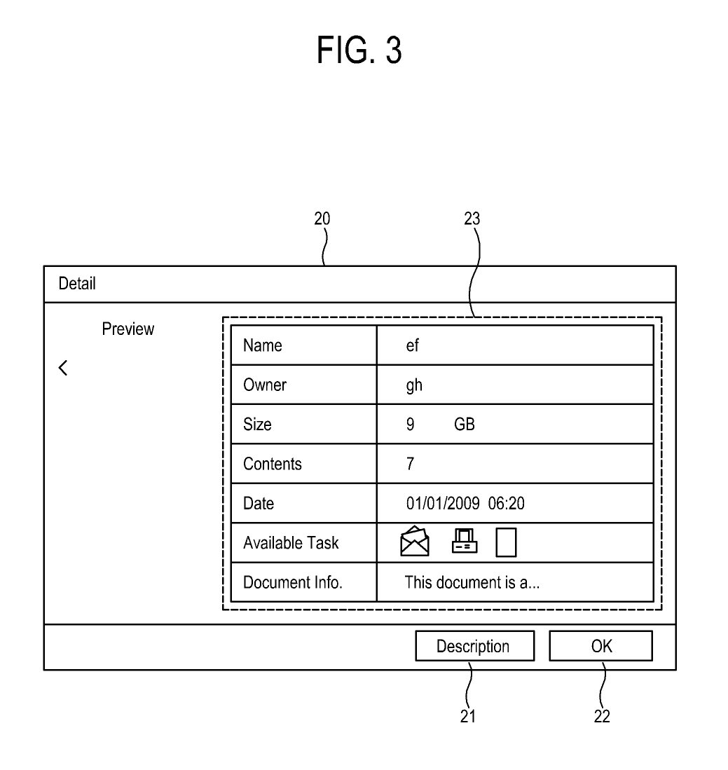

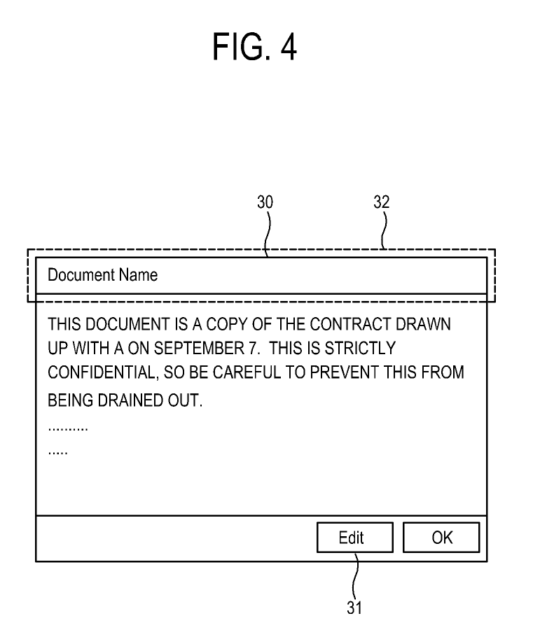

FIG. 2 is a view illustrating the document list screen 10 according to an exemplary embodiment of the present general inventive concept, FIG. 3 is a view illustrating a document detail information screen 20, and FIG. 4 is a view illustrating a document description information screen 30.

As illustrated in FIG. 2, the document list screen 10 includes a plurality of check boxes 11 to allow for selection of at least one of documents listed in a document list, and a detail information button 12 to allow for confirmation of information of the selected document.

A user can select at least one document from the document list screen 10 illustrated in FIG. 2 and confirm detail information on the selected document by touching the detail information button 12. In this embodiment, the detail information may be included in description information of the document.

When a user touches the detail information button 12 to select the detail information on the document, the control unit 160 may control the display unit 120 to display the detail information screen 20 as illustrated in FIG. 3.

As illustrated in FIG. 3, the detail information screen 20 may include detail information area 23 such as a document name, owner, size, contents, date, available task, document info. and the like, a description information button 21, and an OK button 22.

The user can select a description information input menu by touching the description information button 21 on the detail information screen 20 as illustrated in FIG. 3.

In this example embodiment, the control unit 160 may determine whether or not there exists description information set for a document selected in FIG. 2 and, if there exists no description information set for the document, the control unit 160 may control the display unit 120 to display a UI to allow for selection of a description information input menu (not illustrated).

In addition, the control unit 160 may control the display unit 120 to display the description information screen 30 as illustrated in FIG. 4 in response to the selection of the description information input menu by the user.

In an example embodiment, if there exists any description information set for a document, description information directly input by the user is displayed on the description information screen 30, as illustrated in FIG. 4. If there exists no description information set for the document, no information is displayed on the description information screen 30.

In an example embodiment, when the detail information screen 20 is displayed, a user may determine from the detail information screen 20 whether additional description information is available for a selected document or documents. For instance, the description information button 21 may be programmed to blink or be constantly illuminated to inform a user that description information exists for a document. By providing the blinking or constantly illuminated button 21, a user need not waste time checking the description information screen 30 if little or no information exists for a particular document.

The detail information area 23 of the detail information screen 20 may also include a box to preview document description information illustrated in the document description information screen 30. When little or no detail information is available for a document, this little or no information may be displayed in the detail information area 23 so that a user may acquire or preview the detail information before selecting the description button 21.

The user may input the document description information in the document description information screen 30 or edit description information which has been already input, by touching an edit button 31.

In this example embodiment, the input description information may be information that the user can use to identify document contents and notice at once, as illustrated in FIG. 4.

Also, in the document description information screen 30 there may be a heading area 32 that may display the name of the document selected in which to view corresponding document description information. In this way the document description information screen 30 may display the selected document and the description information together if there exists any description information set for the document.

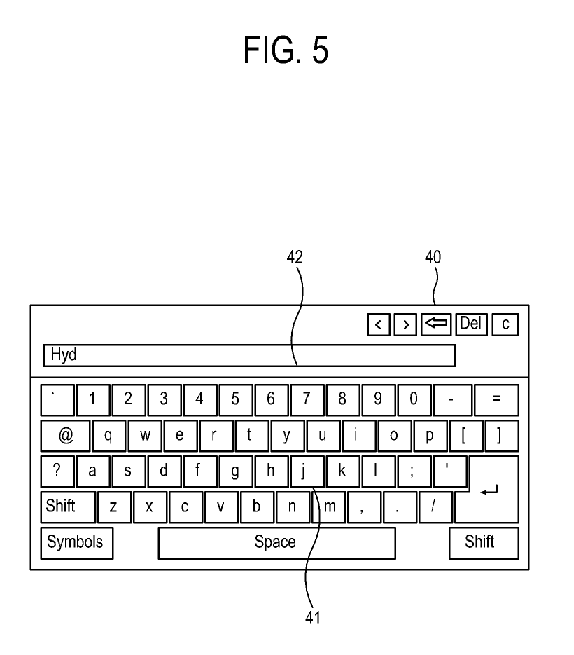

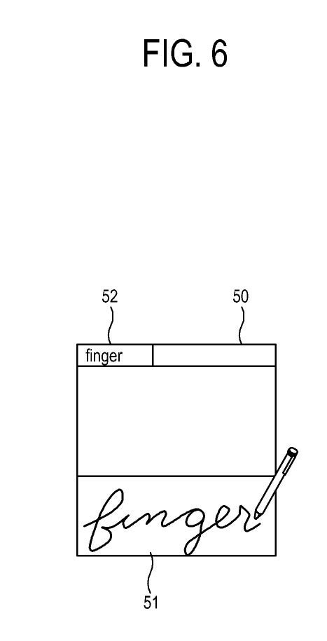

When the user selects the description to be input or edited, the control unit 160 controls the display unit 120 to display a GUI screen for input of the description information, as illustrated in FIG. 5 or 6. Also, manual push-button keyboard or keypad may be used to input or edit the description information.

On the other hand, if there exists any description information which has been already set for the document selected in FIG. 2, the control unit 160 may control the display unit 120 to display the description information along with the selected document.

FIGS. 5 and 6 are views illustrating data input on a touch screen according to an exemplary embodiment of the present general inventive concept. FIG. 5 illustrates a soft keyboard 40 and FIG. 6 illustrates a handwriting input window 50. Though not illustrated, a keyboard with push-button depressible type keys mounted on an image forming apparatus may also be used in the present general inventive concept.

A user may use the soft keyboard 40 illustrated in FIG. 5 to input description information regarding a document of interest or may use the handwriting input window 50 illustrated in FIG. 6 to input description information of a document of interest with a digital pen.

In more detail, the user may use character input keys 41 on the soft keyboard 40 to input description information regarding a document of interest and may confirm that the input description information is being correctly input through a confirmation area 42. In addition, the user may use the digital pen to input the description information regarding a document of interest in an input area 51 of the handwriting input window 50 illustrated in FIG. 6 and may confirm the input description information through a confirmation area 52. The handwriting input window may make use of OCR software to decipher words, numbers, letters and other images input to the input area 51 to be displayed on the confirmation area 52.

In an alternative embodiment, if a hard keyboard for character input is provided in an operation unit of the image forming apparatus 100, the user may use the hard keyboard to input description information.

As another alternative embodiment, the image forming apparatus 100 of the present general inventive concept may receive description information from an external keyboard connected to, for example, the USB port of the communication unit 150.

Once description information is input using the GUI as illustrated in FIG. 5 or 6, the control unit 160 may store the input description information in the storing unit 140 in association with the corresponding document.

In this embodiment, if a stored original document is a document of a format which supports meta data, the control unit 160 may update the stored document information to include the meta data containing the input description information and store the updated document in the storing unit 140.

On the other hand, if the stored original document is not a document of a format which supports meta data, the control unit 160 may store the description information in the storing unit 140 in the form of a separate file of a preset format (for example, html, txt, doc, etc.), and link the stored description information with the stored original document.

Accordingly, when the user later selects the corresponding document from the document list screen 10 illustrated in FIG. 2, the user can simply confirm the description information on the description information screen 30 illustrated in FIG. 4.

In addition, the control unit 160 may control the image forming unit 130 to print the stored description information along with the stored document or may selectively print only the description information.

In addition, the control unit 160 may control the communication unit 150 to transmit the stored document, along with the description information, to the external device 201 via an email or the like.

Accordingly, the image forming apparatus 100 of the present general inventive concept may allow the user to easily identify documents stored in an apparatus by allowing the user to input description information of the stored documents using a soft keyboard within a GUI of the touch screen 112, a hard keyboard with the operation unit, an external keyboard connectable to the communication unit 150, etc., all of which may be provided as the user input unit 110 of the image forming apparatus 100.

In addition, the user may merge a plurality of documents in the stored document list as illustrated in FIG. 2 or split one document into a plurality of documents.

The control unit 160 may generate a UI to allow the user to input description information regarding the documents merged or split according to an instruction from the user and display the generated UI on the display unit 120.

When the user selects to input description information regarding the merged or split documents, the control unit 160 can receive the description information through the GUI using the input techniques illustrated in FIG. 5 or 6. The input description information is stored in the form of a separate file as the information is connected to the merged or split documents, that is, stored as meta data or linked with the documents. The stored description information is also editable.

In an example embodiment, if there exists description information set for merged or split original documents, the user may edit the set description information through a description information input user interface (UI) as described herein.

In addition, the image forming apparatus 100 of the present general inventive concept may provide a description information retrieval function for stored documents.

In more detail, when a user selects the description information retrieval function, the control unit 160 may receive a key word from the user through the GUI as illustrated in FIG. 5 or 6. The key word input is not limited to a single word, but may include a plurality of words, one or more sentences, or character sets such as numerals and special characters that may be used to identify a given document.

Upon receiving the key word from the user, the control unit 160 can determine whether or not a document containing the received key word is included in the description information of the documents stored in the storing unit 140, and may control the display unit 120 to display a retrieved document list.

Accordingly, if the user can not only easily identify the documents using the description information, the user may be able to simply retrieve required documents using the description information retrieval function.

In addition, the image forming apparatus 100 of the present general inventive concept may be configured to receive a key word from the external device 201 connectable by the communication unit 150 and retrieve the stored documents based on the received key word. In this embodiment, the user may retrieve the documents stored in the storing unit 140 of the image forming apparatus 100 using a dedicated application or web browser which is installed in the external device 201 to allow for data exchange with the image forming apparatus 100. The control unit 160 can control the communication unit 150 to transmit a retrieved document list to the external device 201.

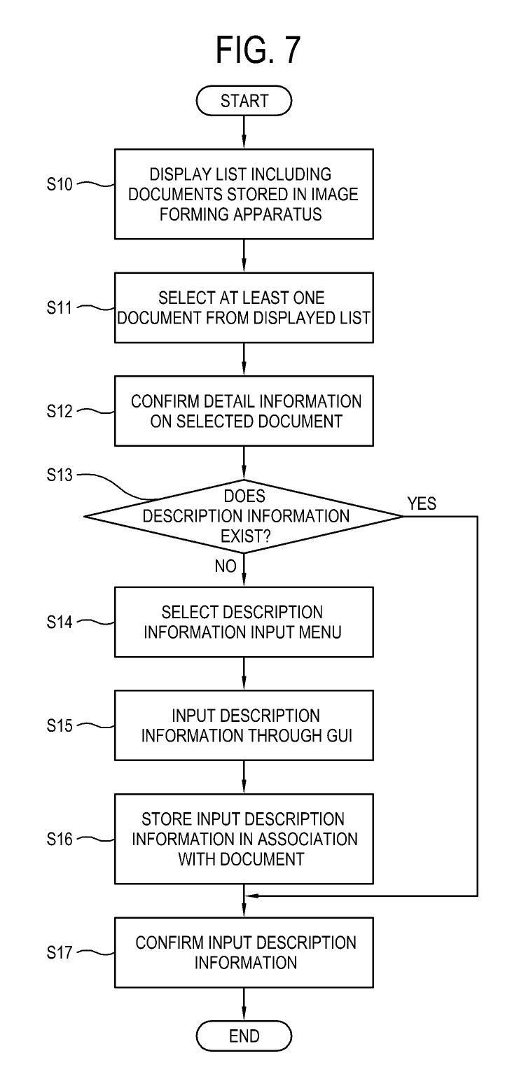

Hereinafter, a document description information input process of the image forming apparatus 100 as configured above will be described with reference to FIGS. 7 to 9.

FIG. 7 is a flow chart illustrating a document description information input process in the image forming apparatus 100 according to an exemplary embodiment of the present general inventive concept.

As illustrated in FIGS. 1 and 7, the display unit 120 may display a list (as illustrated in FIG. 2) including documents stored in the storing unit 140 provided in the image forming apparatus 100 (operation S10).

A user may select at least one document from the document list displayed at operation S10 (operation S11).

The user may confirm detail information (as illustrated in FIG. 3) on the document selected at operation S11 (operation S12).

The control unit 160 determines whether or not there exists any description information set for the selected document (operation S13).

If it is determined at operation S13 that there exists no set description information (NO), the user may select a description information input menu (operation S14).

When the description information is selected to be input at operation S14, the control unit 160 receives the description information on the document through the GUI as illustrated in FIG. 5 or 6 (operation S15). In an exemplary embodiment, the image forming apparatus 100 may be configured to receive description information through the input buttons 111 (i.e., a hard keyboard) or an external keyboard connected via the communication unit 150.

The control unit 160 may store the description information input at operation S15 in the storing unit 140 to correspond to the document stored in the storing unit 140 (operation S16).

Next, the control unit 160 may control the display unit 120 to allow the user to confirm the input description information (operation S17).

On the other hand, if it is determined at operation S13 that there exists any set description information, the control unit 160 may control the display unit 120 to allow the user to confirm the set description information (operation S17). In this embodiment, the display unit 120 may display the set description information along with the document.

In this embodiment, if there exists any set description information, the user may select to edit the set description information.

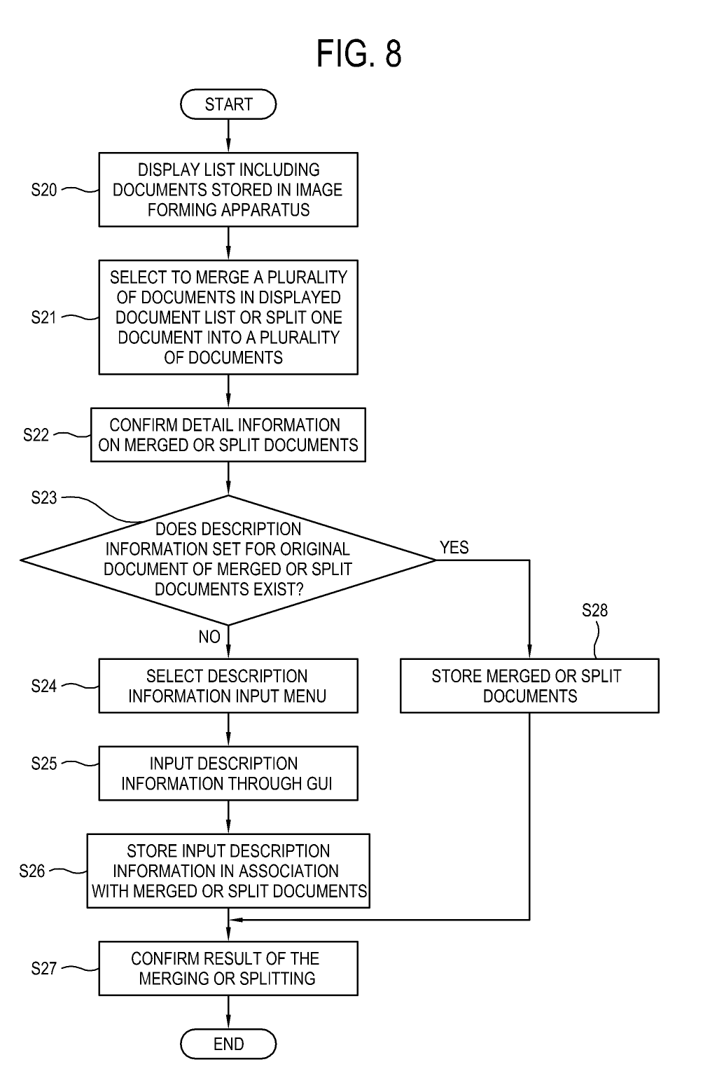

FIG. 8 is a flow chart illustrating a document description information input process in the image forming apparatus 100 according to another exemplary embodiment of the present general inventive concept. FIG. 8 illustrates an exemplary embodiment in which documents stored in the storing unit 140 of the image forming apparatus 100 are merged or split and description information on the merged or split documents is input.

As illustrated in FIGS. 1 and 8, the display unit 120 may display a list (as illustrated in FIG. 2) including at least one document stored in the storing unit 140 provided in the image forming apparatus 100 (operation S20).

A user may select to merge a plurality of documents in the document list displayed at operation S20 or split one document into a plurality of documents (operation S21).

The user may confirm detail information on the merged or split documents through the detail information screen 20 as illustrated in FIG. 3 (operation S22).

The control unit 160 determines whether or not there exists any description information on original document of the merged or split document (operation S23).

If it is determined at operation S23 that there exists no set description information, the user may select a description information input menu to allow the user to input description information on the documents merged or split at operation S21 (operation S24).

When the description information input menu is selected at operation S24, the control unit 160 receives the description information on the merged or split documents through the GUI as illustrated in FIG. 5 or 6 (operation S25). In this embodiment, the image forming apparatus 100 may be configured to receive description information through the input buttons 111 (i.e., a hard keyboard) or an external keyboard connected via the communication unit 150.

The control unit 160 may store the description information input at operation S25 in the storing unit 140 to correspond to the document stored in the storing unit 140 (operation S26).

On the other hand, if it is determined at operation S23 that there exists description information set for original document of the merged or split documents, the control unit 160 may store the merged or split documents in the storing unit 140 (operation S28).

In an example embodiment, if there exists description information set for an original document of the merged or split documents, the user may select to edit the set description information.

The control unit 160 may control the display unit 120 to allow the user to confirm the merged or spit documents (operation S27).

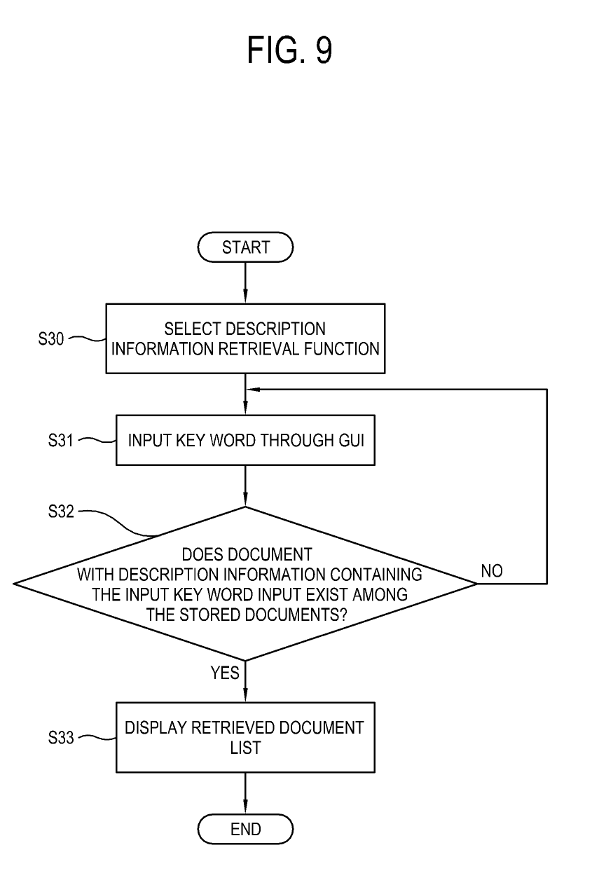

FIG. 9 is a flow chart illustrating a description information retrieval process using the description information input in FIG. 7 or 8.

As illustrated in FIGS. 1 and 9, a user may select a description information retrieval function for documents stored in the storing unit 140 of the image forming apparatus 100 (operation S30).

The control unit 160 controls the display unit 120 to display a GUI to input a key word in response to the selection of the description information retrieval function at operation S30, and the user may input a key word through the displayed GUI (operation S31). In this embodiment, the retrieval may be also performed by the external device 201 connectable to the image forming apparatus 100.

The control unit 160 may determine whether or not there exists any document with description information containing the key word input at operation S31 among the stored documents (operation S32).

If it is determined at operation S32 that there exists a document with description information containing the key word, the control unit 160 may control the display unit 120 to display a retrieved document list (operation S33). If a document does not exist, the control unit 160 may prompt a user to enter a different key word in order to retrieve a document from the document list.

As described above, according to the image forming apparatus 100 and the document description information input method of the present general inventive concept, it is possible to easily identify documents required by a user by inputting description information on documents stored in the apparatus through a GUI and storing the input description information to correspond to the stored document.

In particular, it is possible to improve user's convenience of simple retrieval of documents required by a user by enabling prompt input of description information on merged or split documents and providing a description information retrieval function.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A document description information input method in an image forming apparatus including a display unit on which a graphic user interface is displayed and a storing unit in which at least one document is stored, comprising:
displaying a list including at least one document on the display unit;
selecting at least one document from the list;
determining whether there exists any description information set for the document;
selecting a description information input menu if there exists no description information set for the document; and
inputting the description information in the image forming apparatus using the description information input menu.

2. The document description information input method according to claim 1, further comprising displaying the selected document and the description information together if there exists any description information set for the document.

3. The document description information input method according to claim 1, further comprising storing the input description information as meta data contained in the document or storing the input description information in the form of a separate file, wherein the separate file is linked with the document.

4. The document description information input method according to claim 3, wherein the stored description information is editable.

5. The document description information input method according to claim 1, wherein the inputting the description information includes inputting the description information using a soft keyboard in the graphic user interface of the image forming apparatus or using input buttons of the image forming apparatus.

6. The document description information input method according to claim 1, wherein the document is retrievable using the input description information.

7. The document description information input method according to claim 6, wherein the document retrieval is performed using the graphic user interface or by an external device connectable to the image forming apparatus.

8. The document description information input method according to claim 1, further comprising merging a plurality of documents stored in the storing unit into a single document or splitting a single document into a plurality of documents,
wherein, for the merging or the splitting, the set description information is edited or new description information is input.

9. An image forming apparatus which is capable of inputting description information, comprising:
a display unit on which a graphic user interface is displayed;
a user input unit which receives a user selection in to correspond to the displayed graphic user interface;
a storing unit in which at least one document is stored, and
a control unit which controls the display unit to display a list including the at least one document stored in the storing unit, determines whether there exists any description information set for the document upon receiving a selection of at least one document from the list through the user input unit, and controls the display unit to display a graphic user interface to allow for a selection of a description information input menu and input of the description information using the description information input menu if there exists no description information set for the document.

10. The image forming apparatus according to claim 9, wherein the selected document and the description information are displayed together if there exists any description information set for the document.

11. The image forming apparatus according to claim 9, wherein the control unit stores the input description information as meta data contained in the document or stores the input description information in the form of a separate file linked with the document.

12. The image forming apparatus according to claim 11, wherein the stored description information is editable.

13. The image forming apparatus according to claim 9, wherein the user input unit includes at least one of a soft keyboard in the graphic user interface and input buttons.

14. The image forming apparatus according to claim 9, wherein the document is retrievable using the input description information.

15. The image forming apparatus according to claim 14, wherein the document retrieval is performed using the graphic user interface or by an external device connectable to the image forming apparatus.

16. The image forming apparatus according to claim 9, wherein the user input unit selects to merge a plurality of documents stored in the storing unit into a single document or split a single document into a plurality of documents,
wherein, for the merging or the splitting, the set description information is edited or new description information is input.

17. An image forming apparatus which is capable of inputting description information, comprising:
an operation unit which receives a user selection through a touch screen on which a graphic user interface is displayed;
a storing unit in which at least one document is stored, and
a control unit which controls the operation unit to display a list including the at least one document stored in the storing unit, determines whether there exists any description information set for the document upon receiving a selection of at least one document from the list through the touch screen, and controls the operation unit to display a graphic user interface to allow for a selection of a description information input menu and input of the description information using the description information input menu if there exists no description information set for the document.

18. A document description determination method in an image forming apparatus including a display unit and a storing unit in which at least one document is stored, comprising:
displaying a selectable document list on the display unit with corresponding check boxes to select at least one document;
selecting at least one of the documents from the document list to view description information about the document;
displaying a detail information screen on the display unit in order to view the description information about the document; and
determining from the detail information screen whether additional description information is available for the selected document.

19. The method of claim 18, further comprising selecting a button on the display unit in order to view the description information about the document.

20. The method of claim 18, wherein the determining from the detail information screen includes determining whether a description information button is blinking or illuminated to indicate whether additional description information is available for the selected document.

21. The method of claim 18, wherein the determining from the detail information screen includes determining whether a document information area exists for the selected document.

22. An image forming apparatus which is capable of determining description information, comprising:
a display unit to display a selectable document list with corresponding check boxes to select at least one document and to display a detail information screen in order to view description information about the document;
a user input unit to allow a user to select at least one of the documents from the document list to view the description information about the document and determine from the detail information screen whether additional document information is available for the selected document.

23. The apparatus of claim 22, further comprising a description information button on the display unit in order to view the description information about the document.

24. The apparatus of claim 23, wherein the description information button blinks or illuminates to indicate whether additional description information is available for the selected document.

25. The apparatus of claim 22, wherein the detail information screen includes a detail information area to indicate whether additional description information is available for the selected document.
